(19) United States
(12) Patent Application Publication
(10) Pub. No.: US 2026/0194724 A1
(43) Pub. Date: Jul. 9, 2026

(54) Unitary Carrier and Optical Transceiver Device Including Same

(71) Applicant: 3M INNOVATIVE PROPERTIES COMPANY, St. Paul, MN (US)

(72) Inventors: Changbao Ma, Austin, TX (US); Joseph E. Miller, Pflugerville, TX (US); Kevin T. Chaloupka, Hutto, TX (US)

(21) Appl. No.: 19/134,791

(22) PCT Filed: Dec. 1, 2023
(86) PCT No.: PCT/IB2023/062149

§ 371 Date: Jun. 2, 2025

Related U.S. Application Data
(60) Provisional application No. 63/387,538, filed on Dec. 15, 2022.

(51) Int. Cl. G02B 6/42

(52) U.S. Cl. CPC G02B 6/4245; G02B 6/4202; G02B 6/4228; G02B 6/4246; G02B 6/4261; G02B 6/428; G02B 6/4292

(57) ABSTRACT

An optical transceiver device (300) includes a housing (10) having a first mating end (11) and an opposite second mating end (12), and a circuit board (20) at least partially disposed inside the housing (10) and including a plurality of electrically conductive first pads (21) disposed proximate the first mating end (11) of the housing (10) and at least one optical transceiver (22a, 22b) in electrical communication with at least some of the first pads (21). A unitary carrier (30) includes at least one resilient arm (31a, 31b). The optical transceiver device (300) includes the unitary carrier (30) disposed inside the housing (10) proximate the second mating end (12) of the housing (10) with the at least one resilient arm (31a, 31b) forcibly reversibly flexed by the housing (10) to fixedly engage the unitary carrier (30) with the housing (10), and includes an optical ferrule (40) at least partially disposed inside the unitary carrier (30) proximate the second mating end (12) of the housing (10).

### TECHNICAL FIELD

The present description relates generally to optical transceiver devices and to unitary carriers that can be utilized in optical transceiver devices.

### BACKGROUND

An optical transceiver module may include a circuit board and an optical ferrule.

### SUMMARY

In some aspects, the present description provides an optical transceiver device including a housing having a first mating end and an opposite second mating end; a circuit board at least partially disposed inside the housing and including a plurality of electrically conductive first pads disposed proximate the first mating end of the housing and at least one optical transceiver in electrical communication with at least some of the first pads and comprising at least one of an optical light source and an optical light detector; a unitary carrier disposed inside the housing proximate the second mating end of the housing and including at least one resilient arm forcibly reversibly flexed by the housing to fixedly engage the unitary carrier with the housing; and an optical ferrule at least partially disposed inside the unitary carrier proximate the second mating end of the housing and configured to mate with a mating optical ferrule of a mating optical connector. The optical ferrule can include a first attachment area for receiving and permanently attaching to a plurality of optical fibers in optical communication with at least some of the at least one optical transceiver, and a light redirecting member for changing a direction of light received from an optical fiber received by, and permanently attached to, the first attachment area.

In some aspects, the present description provides a unitary carrier configured to be forcibly and reversibly assembled to a housing of an optical transceiver device. Th unitary carrier has a unitary construction extending between opposing front and rear ends of the unitary carrier. The unitary carrier includes a front portion defining a cavity for receiving and supporting an optical ferrule of the optical transceiver device; a rear portion extending from the rear open end of the cavity to the rear end of the unitary carrier; and a pair of resilient wing arms disposed on, and extending from, opposite sides, of the rear portion of the unitary carrier, such that when the unitary carrier is assembled to the housing of the optical transceiver device, the resilient wing arms are forcibly reversibly flexed by the housing to fixedly engage the unitary carrier with the housing. The cavity can include a closed top and a closed bottom and extending from a rear open end of the cavity to a front open end of the cavity disposed at or near the front end of the unitary carrier. The rear portion can include a compartment for removably receiving and securing a fiber-cable carrier permanently attached to a plurality of optical fibers permanently attached to the optical ferrule.

These and other aspects will be apparent from the following detailed description. In no event, however, should this brief summary be construed to limit the claimable subject matter.

### BRIEF DESCRIPTION OF THE DRAWINGS

FIG. 1 is a schematic top perspective view of an optical transceiver device, according to some embodiments.

FIG. 2 is a schematic top perspective cutaway view of a portion of the optical transceiver device of FIG. 1, according to some embodiments.

FIG. 3 is a schematic end perspective view of the optical transceiver device of FIG. 1, according to some embodiments.

FIG. 4 is a schematic top perspective view of an optical transceiver, according to some embodiments.

FIG. 5 is a schematic top perspective view of a portion of an optical transceiver device including at least one discrete package at least partially disposed in an opening of a circuit board, according to some embodiments.

FIG. 6 is a schematic top perspective view of a portion of an optical transceiver device without an adaptor, according to some embodiments.

FIG. 7 is a schematic top perspective view of a unitary carrier and a fiber-cable carrier attached to a plurality of optical fibers, according to some embodiments.

FIG. 8 is a schematic bottom perspective view of a unitary carrier and a plurality of optical fibers, according to some embodiments.

FIG. 9 is a schematic top perspective view of the unitary carrier of FIG. 7, according to some embodiments.

FIG. 10 is a schematic top perspective view of the unitary carrier of FIG. 8, according to some embodiments.

FIG. 11 is a schematic top perspective view of an optical transceiver device mated with a mating optical connector, according to some embodiments.

FIG. 12 is a schematic perspective cutaway view of portions of the optical transceiver device and the mating optical connector of FIG. 11, according to some embodiments.

FIG. 13 is a schematic cross-sectional view of portions of the optical transceiver device and the mating optical connector of FIG. 11, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, an optical transceiver device includes a unitary carrier (e.g., a cassette for receiving and supporting an optical ferrule and for receiving a fiber-cable carrier) that includes resilient feature(s) (e.g., at least one resilient arm) that can be forcibly reversibly flexed by the housing of the optical transceiver device to fixedly engage the unitary carrier with the housing. In some embodiments, the unitary carrier enables repeatable mechanical registration and mating of connectors, without the use of discrete (e.g., metal) spring(s) which are commonly used to push a connector cassette against a registration feature in a transceiver housing, for example. Traditional physical contact connectors include an internal (e.g., metal) spring to provide the force needed for mating of the ferrules. According to some embodiments of the present description, the optical transceiver device can include an optical ferrule which can utilize expanded beam optics (EBO), for example. Such optical ferrules typically do not need the strong mating force needed to mate physical contact connectors. It has been found, according to some embodiments, that the resilient feature(s) of the unitary carrier provides a desired mating force between the optical ferrules, even when the unitary carrier is made of plastic, for example, and that no separate internal (e.g., metal) spring(s) are needed. EBO ferrules, and other optical ferrules and optical connectors, are described in Int. Pat. Appl. Pub. No. WO 2022/172107 (Ma) and U.S. Pat. Appl. Pub. Nos. 2015/0219863 (Haase et al.); 2015/0234126 (Haase et al.); 2020/0278501 (Ma et al.); 2022/0146760 (Tang et al.); and 2022/0260794 (Tang et al.), for example. The optical transceiver device can utilize any suitable form factor such as a multi-fiber push-on (MPO) form factor, or a fiber-optic connector (FC) form factor, or a snap-in connector (SC) form factor, or Lucent connector (LC) form factor, or SENKO's (SENKO Advanced Components, Inc., Boston, Massachusetts) CS very small form factor (VSFF) connector, or SENKO's SN connector form factor, or SENKO's SN-MT connector form factor, or an optical backplane (e.g., a Molex (Molex LLC, Lisle, IL) HBMT High-density optical Backplane Mechanical Transfer) form factor, for example.

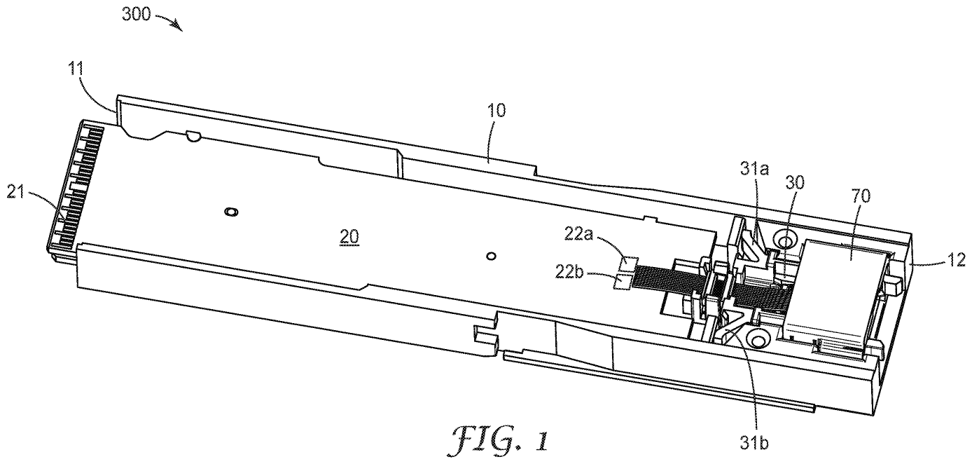

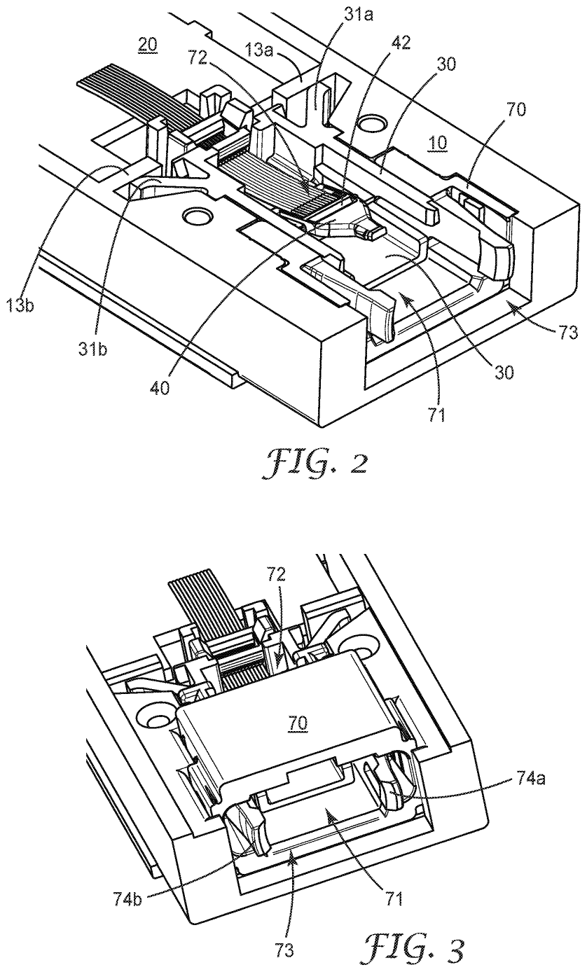

FIG. 1 is a schematic top perspective view of an optical transceiver device 300, according to some embodiments. FIG. 2 is a schematic top perspective cutaway view of a portion of the optical transceiver device 300, according to some embodiments. FIG. 3 is a schematic end perspective view of the optical transceiver device 300, according to some embodiments. In some embodiments, the optical transceiver device 300 includes a housing 10 having a first mating end 11 and an opposite second mating end 12; and a circuit board 20 at least partially disposed inside the housing 10 and including a plurality of electrically conductive first pads 21 disposed proximate the first mating end 11 of the housing 10 and at least one optical transceiver 22a, 22b in electrical communication with at least some (e.g., at least one, or at least two, or all) of the first pads 21 and including at least one of an optical light source and an optical light detector. The circuit board 20 can optionally include a plurality of electrically conductive second pads (e.g., disposed on an opposite side of the circuit board from the first pads 21) at least some of which may be in electrical communication with the at least one optical transceiver 22a, 22b.

FIG. 4 is a schematic top perspective view of an optical transceiver 122, according to some embodiments. Optical transceiver 122 can correspond to optical transceiver 22a and/or 22b. The optical transceiver 122 includes at least one of an optical light source 23a and an optical light detector 23b (both are included in the illustrated embodiment). In some embodiments, the at least one optical transceiver 22a, 22b includes a plurality of optical transceivers 22a and 22b, where each of the optical transceivers includes at least one of an optical light source 23a and an optical light detector 23b. The optical light source 23a can be any suitable optical light source known in the art. Similarly, the optical light detector 23b can be any suitable optical light detector known in the art. Useful light sources and detectors include those described in U.S. Pat. Appl. Publ. Nos. 2015/0131948 (Selli et al.); 2014/0211822 (Fattal et al.); and 2005/0019973 (Chua), for example. In some embodiments, the optical light source 23a includes one or more or an array of laser diodes (LDs). In some embodiments, the optical light detector 23b includes one or more or an array of photodiodes (PDs). In some embodiments, the optical light source 23a includes one or more or an array of transmitter optical subassemblies (TOSAs). In some embodiments, the optical light detector 23b includes one or more or an array of receiver optical subassemblies (ROSAs).

In some embodiments, the at least one optical transceiver 22a, 22b, 122 includes at least one discrete package 29 attached to the circuit board 20 and including at least one optoelectronic die chip comprising the at least one of the optical light source 23a and the optical light detector 23b. In some embodiments, the at least one discrete package 29 is wire (e.g., via wires 25) bonded to the circuit board 20. In some embodiments, the at least one discrete package 29 is attached to the circuit board 20 by a soldering process. In some embodiments, the at least one discrete package 29 is flip-chip bonded to the circuit board 20. In some embodiments, the at least one discrete package 29 is disposed on a pedestal 24 disposed on the circuit board 20.

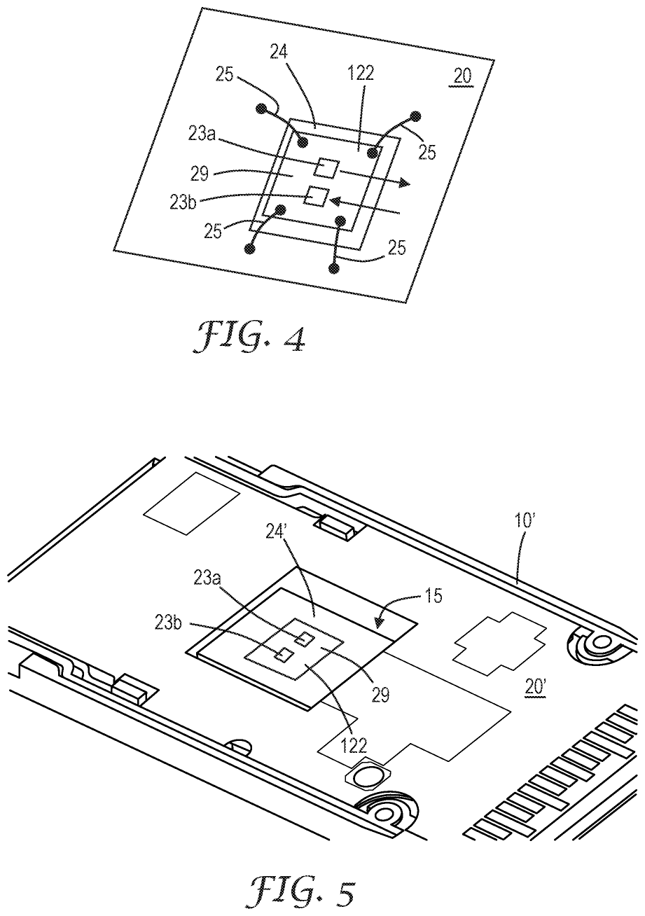

FIG. 5 is a schematic top perspective view of a portion of an optical transceiver device including an optical transceiver 122 including at least one discrete package 29, according to some embodiments. The at least one discrete package 29 is disposed on a pedestal 24′ disposed on a circuit board 20′. In some embodiments, the pedestal 24′ is a heatsink pedestal. In some embodiments, the pedestal 24′ is unitary to the housing 10′. In some such embodiments, or in other embodiments, the housing is made of metal. In some such embodiments, or in other embodiments, the circuit board 20′ defines an opening 15 substantially registered with the pedestal 24′, where the at least one discrete package 29 is at least partially disposed in the opening. The opening can be a through opening.

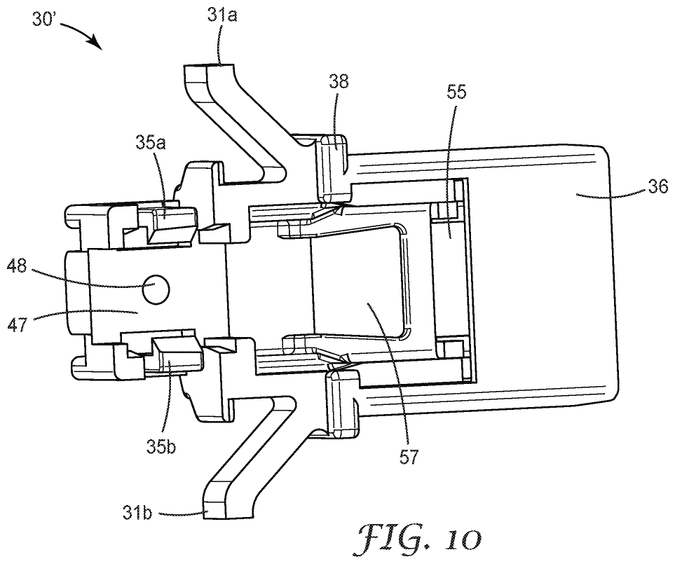

In some embodiments, the optical transceiver device 300 further includes an adaptor 70 (see, e.g., FIGS. 1-3) at least partially disposed inside, and removably assembled to, the housing 10 and configured to receive and secure at least a front portion (see, e.g., front portion 301m schematically illustrated in FIG. 10) of a mating optical connector therein. The adaptor 70 includes a hollow interior 71 extending between a first open end 72 of the adaptor 70 and an opposite second open end 73 of the adaptor 70 disposed between the first open end and the second mating end of the housing 10. In some embodiments, at least portions of an optical ferrule 40 and a unitary carrier 30 (see, e.g., FIG. 2) are disposed in the hollow interior 71 of the adaptor 70. In some embodiments, the adaptor 70 includes at least one flexible latch 74a, 74b (see, e.g., FIG. 3) for securing a mating optical connector to the adaptor 70.

Various portions (e.g., housing, carrier, optical ferrule) of any of the optical transceiver devices described herein can be made by molding (e.g., injection molding a thermoplastic material) or machining, for example. In some embodiments, the carrier 30 has a unitary construction (e.g., formed by molding a same material in a same molding step so that there are no seams between adjacent portions of the carrier). Items that were made at the same time as a single part and are not two separate parts subsequently joined together can be described as unitary to one another, or integral to one another, or formed integrally with one another. The various portions (e.g., housing, carrier, optical ferrule) of any of the optical transceiver devices described herein can be formed from any suitable material such as plastic, metal, or ceramic, for example. In some embodiments, the unitary carrier 30 is made of plastic. In some embodiments, the unitary carrier 30 is made of metal. In some embodiments, the unitary carrier 30 is made of ceramic.

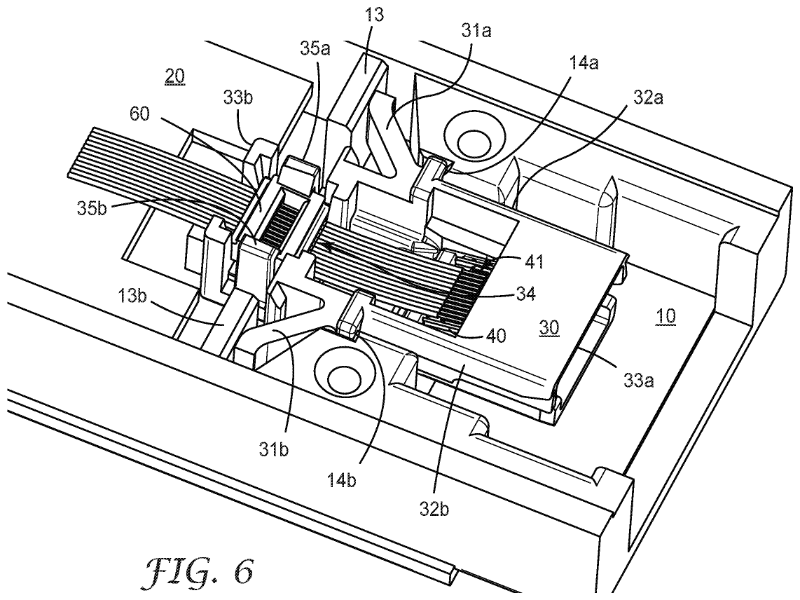

FIG. 6 is a schematic top perspective view of a portion of an optical transceiver device 300 with the adaptor 70 removed, according to some embodiments. In some embodiments, a unitary carrier 30 is disposed inside the housing 10 proximate the second mating end 12 of the housing 10 and includes at least one resilient arm 31a, 31b forcibly reversibly flexed by the housing 10 to fixedly engage the unitary carrier 30 with the housing 10. In some embodiments, the at least one resilient arm 31a, 31b of the unitary carrier 30 is forcibly reversibly flexed by at least one first interior stop 13a, 13b of the housing 10 to forcibly press the unitary carrier 30 against at least one opposite second interior stop 14a, 14b of the housing 10, thereby fixedly engaging the unitary carrier 30 with the housing 10. In some embodiments, the at least one resilient arm 31a, 31b of the unitary carrier 30 includes a pair of spaced apart of resilient arms 31a and 31b. Each of the resilient arms can be forcibly reversibly flexed by the housing to fixedly engage the unitary carrier with the housing. In some embodiments, the spaced apart resilient arms 31a and 31b are disposed on, and extend from, opposite sides 32a and 32b, between opposing front and rear ends 33a and 33b, of the unitary carrier. In some embodiments, the spaced apart resilient arms 31a and 31b are forcibly reversibly flexed away from each other by the housing to fixedly engage the unitary carrier 30 with the housing 10. In some embodiments, each of the spaced apart resilient arms 31a and 31b is forcibly reversibly flexed by a first interior stop 13a, 13b of the housing. In some embodiments, the first interior stop 13a, 13b forcibly presses the unitary carrier 30 against at an opposite second interior stop 14a, 14b of the housing 10, thereby fixedly engaging the unitary carrier 30 with the housing 10.

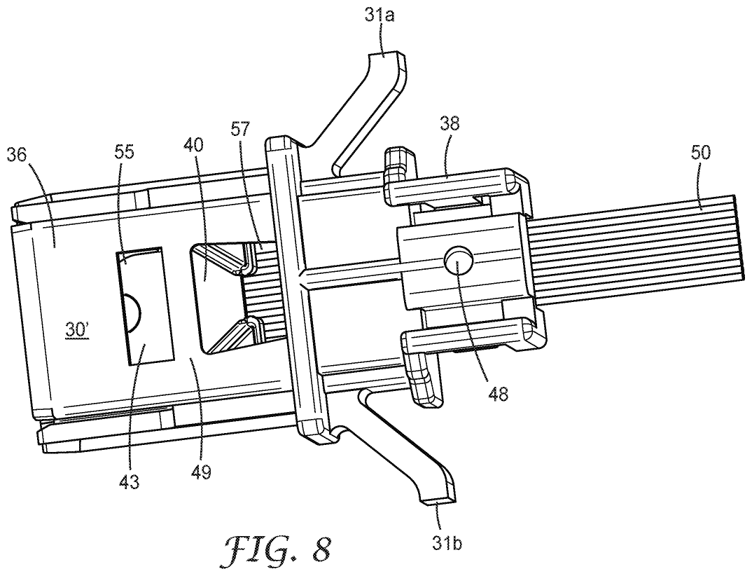

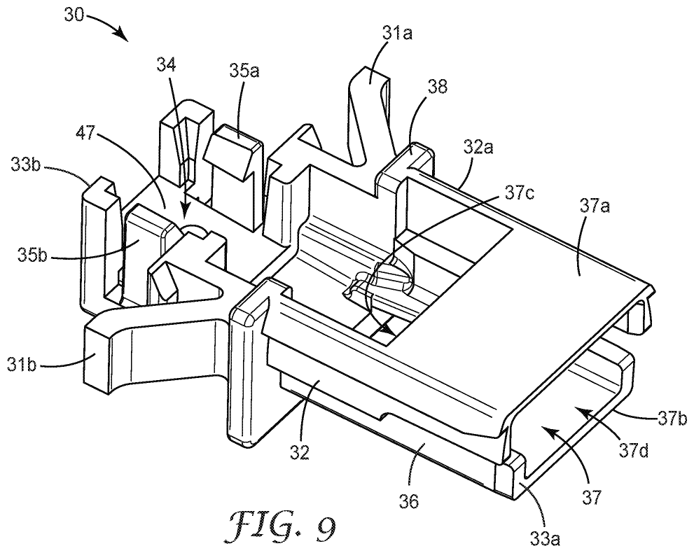

In some embodiments, the optical ferrule 40 includes a first attachment area 41 for receiving and permanently attaching to a plurality of optical fibers 50. In some embodiments, the unitary carrier 30 further includes a second attachment area 34 disposed between the optical ferrule 40 and the first mating end 11 of the housing 10, such that when the plurality of optical fibers 50 is received by, and permanently attached to, the first attachment area 41, the plurality of optical fibers is also received by, and secured to, the second attachment area 34. In some embodiments, the plurality of optical fibers is disposed in, and permanently attached to, a fiber-cable carrier 60, and where the fiber-cable carrier 60 is removably secured to the second attachment area 34. In some embodiments, the second attachment area 34 includes at least one flexible latch 35a, 35b for securing the fiber-cable carrier to the second attachment area 34. The at least one flexible latch 35a, 35b can be disposed on, and extend from, a bottom 47 of the second attachment area 34. For example, the at least one flexible latch can include first and second flexible latches 35a and 35b disposed on, and extending from, respective opposite first and second sides of the bottom 47 of the second attachment area (see, e.g., FIGS. 9 and 10). The second attachment area 34 can define a compartment having an open top for receiving the fiber-cable carrier 60 and an opposite bottom 47. The bottom 47 (of the second attachment area or the compartment) can optionally define a through opening 48 (see, e.g., FIGS. 8 and 10) therein. The through opening 48 can be used for pushing the fiber-cable carrier 60 out from the second attachment area or the compartment during a disassembly process, for example.

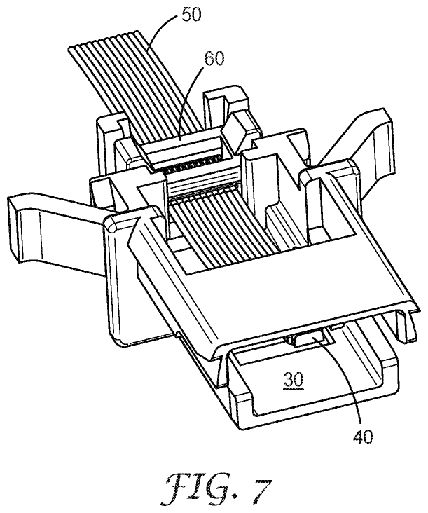

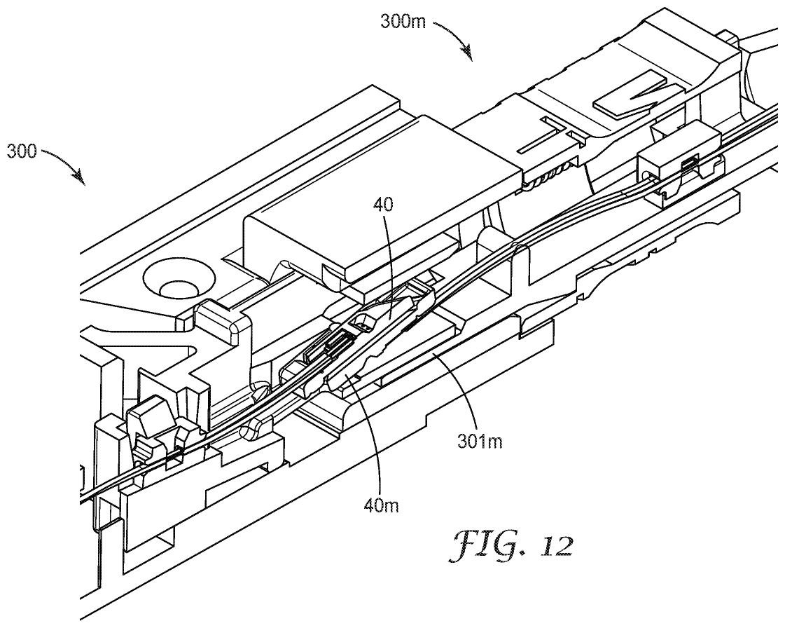

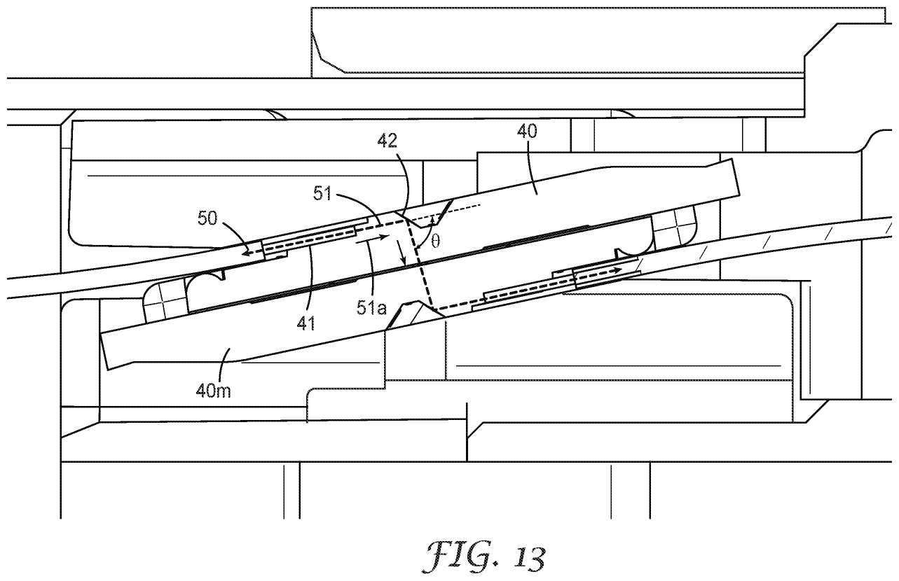

FIG. 7 is a schematic top perspective view of a unitary carrier 30 and a fiber-cable carrier 60 attached to a plurality of optical fibers 50, according to some embodiments. FIG. 8 is a schematic bottom perspective view of a unitary carrier 30′ and a plurality of optical fibers 50, according to some embodiments. In some embodiments, when the optical ferrule 40 in the unitary carrier 30, 30′ is not mated with a mating optical ferrule 40m (see, e.g., FIGS. 12-13), the optical ferrule 40 rests on supports of the unitary carrier 30, 30′. In this case, the optical fibers 50 may be straight or curved depending on the relative position of the fiber-cable carrier 60 and the support, and the orientation of the fiber-cable carrier 60. The unitary carrier 30′ can optionally include an optically transmissive window 55 disposed adjacent a light output surface 43 of the optical ferrule 40 in order to provide access to a light output from the optical ferrule 40. The optically transmissive window can be, for example, a transparent bottom wall or a through opening. For example, in some embodiments, a portion (e.g., bottom portion 49) of the unitary carrier 30′ disposed between the optical ferrule 40 and the housing 10 defines a through opening 55 therein, where the through opening 55 faces a light output surface 43 of the optical ferrule 40. This can allow testing, inspection, and/or cleaning of the optical ferrule 40 without removing the optical ferrule 40 from the unitary carrier 30′ (e.g., after the ferrule 40 and fiber-cable carrier 60 have been assembled to the unitary carrier 30′ but before the unitary carrier is assembled to the housing 10). Optical windows in the housings of optical connectors are described in U.S. Pat. No. 10,989,881 (Ma et al.), for example. The unitary carrier 30′ can optionally include a through opening 57 disposed between the light output surface 43 of the optical ferrule 40 and the second attachment are 34. The through opening 57 can in be included to provide additional space for an end portion of a mating optical ferrule 40m (see, e.g., 13), for example.

FIG. 9 is a schematic top perspective view of the unitary carrier 30, according to some embodiments. FIG. 10 is a schematic bottom perspective view of the unitary carrier 30′, according to some embodiments. The unitary carrier 30′ can correspond to unitary carrier 30 except that unitary carrier 30′ may define one or more optional through openings. In some embodiments, a unitary carrier 30, 30′ is configured to be forcibly and reversibly assembled to a housing 10 of an optical transceiver device 300 and has a unitary construction extending between opposing front and rear ends 33a and 33b of the unitary carrier 30, 30′. The unitary carrier 30, 30′ can include a front portion 36 defining a cavity 37 for receiving and supporting an optical ferrule 40 of the optical transceiver device 300. The cavity 37 can include a closed top 37a and a closed bottom 37b and extending from a rear open end 37c of the cavity 37 to a front open end 37d of the cavity 37 disposed at or near the front end 33a of the unitary carrier 30. The unitary carrier 30, 30′ can include a rear portion 38 extending from the rear open end 37c of the cavity 37 to the rear end 33b of the unitary carrier 30, 30′ and including a compartment 34 for removably receiving and securing a fiber-cable carrier 60 (see, e.g., FIGS. 6-7) permanently attached to a plurality of optical fibers 50 permanently attached to the optical ferrule 40. The unitary carrier 30, 30′ can include a pair of resilient wing arms 31a, 31b disposed on, and extending from, opposite sides 32a, 32b, of the rear portion 38 of the unitary carrier 30, 30′, such that when the unitary carrier 30, 30′ is assembled to the housing 10 of the optical transceiver device 300, the resilient wing arms 31a, 31b are forcibly reversibly flexed by the housing 10 to fixedly engage the unitary carrier 30, 30′ with the housing 10. In some embodiments, the compartment 34 has an open top for receiving the fiber-cable carrier 60 and an opposite bottom 47. In some embodiments, the compartment 34 includes spaced apart flexible latches 35a, 35b for securing the fiber-cable carrier 60 to the unitary carrier 30, 30′, where the flexible latches 35a, 35b are disposed on, and extend from, opposite sides of the bottom 47 of the compartment 34. In some embodiments, the bottom of the compartment 34 defines a through opening 48 therein.

In some embodiments, the front portion 36 of the unitary carrier 30′ includes a bottom portion 49 including the closed bottom 37b of the cavity 37 where the bottom portion 49 includes an optically transmissive window 55 configured so that when the optical ferrule 40 is received in the cavity 37, the optically transmissive window 55 faces a light output surface 43 of the optical ferrule 40. In some embodiments, the front portion 36 of the unitary carrier 30′ includes a bottom portion 49 including the closed bottom 37b of the cavity 37 where the bottom portion 49 defines at least one through opening 55, 57 therein. In some embodiments, the at least one through opening 55, 57 includes a first through opening 55 configured so that when the optical ferrule 40 is received in the cavity 37, the first through opening 55 faces a light output surface 43 of the optical ferrule 40. In some embodiments, the at least one through opening 55, 57 includes a second through opening 57 disposed between the first through opening 55 and the rear portion 38 of the unitary carrier 30, 30′. The through opening 55 can be included for inspection and testing of the optical ferrule 40 and/or the through opening 57 can be included to provide additional room for an end portion of a mating optical ferrule 40m, as described further elsewhere herein.

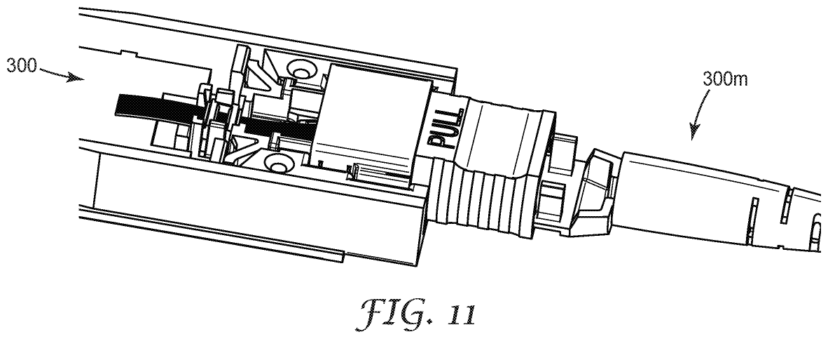

FIG. 11 is a schematic top perspective view of an optical transceiver device 300 mated with a mating optical connector 300m, according to some embodiments. FIG. 12 is a schematic perspective cutaway view of portions of the optical transceiver device 300 and the mating optical connector 300m, according to some embodiments. In some embodiments, the optical transceiver device 300 includes an optical ferrule 40 at least partially disposed inside the unitary carrier 30 proximate the second mating end 12 of the housing 10 and configured to mate with a mating optical ferrule 40m of a mating optical connector 300m. FIG. 13 is a schematic cross-sectional view of portions of the optical transceiver device 300 and the mating optical connector 300m schematically illustrating the optical ferrule 40 mated with the mating optical ferrule 40m, according to some embodiments. In some embodiments, the optical ferrule 40 includes a first attachment area 41 for receiving and permanently attaching to a plurality of optical fibers 50 in optical communication with at least some (e.g., at least one, or at least two, or all) of the at least one optical transceiver, and a light redirecting member 42 for changing a direction 51a of light 51 received from an optical fiber 50 received by, and permanently attached to, the attachment area. In some embodiments, the light redirecting member 42 changes the direction (e.g., angle θ in FIG. 13) of the received light by at least 0.5, or 1, or 2, or 5, or 10, or 15, or 20, or 25, or 30, or 35, or 40 degrees. The direction can be changed by up to about 160, or 140, or 120, or 100 degrees, for example.

A first embodiment is an optical transceiver device comprising: a housing having a first mating end and an opposite second mating end; a circuit board at least partially disposed inside the housing and comprising a plurality of electrically conductive first pads disposed proximate the first mating end of the housing and at least one optical transceiver in electrical communication with at least some of the first pads and comprising at least one of an optical light source and an optical light detector; a unitary carrier disposed inside the housing proximate the second mating end of the housing and comprising at least one resilient arm forcibly reversibly flexed by the housing to fixedly engage the unitary carrier with the housing; and an optical ferrule at least partially disposed inside the unitary carrier proximate the second mating end of the housing and configured to mate with a mating optical ferrule of a mating optical connector, the optical ferrule comprising a first attachment area for receiving and permanently attaching to a plurality of optical fibers in optical communication with at least some of the at least one optical transceiver, and a light redirecting member for changing a direction of light received from an optical fiber received by, and permanently attached to, the first attachment area.

A second embodiment is the optical transceiver device of the first embodiment, wherein the at least one optical transceiver comprises at least one discrete package attached to the circuit board and comprising at least one optoelectronic die chip comprising the at least one of the optical light source and the optical light detector.

A third embodiment is the optical transceiver device of the first or second embodiments, wherein the at least one optical transceiver comprises a plurality of optical transceivers, each of the optical transceivers comprising at least one of an optical light source and an optical light detector.

A fourth embodiment is the optical transceiver device of any one of the first through third embodiments, wherein the at least one resilient arm of the unitary carrier comprises a pair of spaced apart of resilient arms, each of the resilient arms forcibly reversibly flexed by the housing to fixedly engage the unitary carrier with the housing.

A fifth embodiment is the optical transceiver device of the fourth embodiment, wherein the spaced apart resilient arms are forcibly reversibly flexed away from each other by the housing to fixedly engage the unitary carrier with the housing.

A sixth embodiment is the optical transceiver device of the fifth embodiment, wherein each of the spaced apart resilient arms is forcibly reversibly flexed by a first interior stop of the housing.

A seventh embodiment is the optical transceiver device of the sixth embodiment, wherein the first interior stop forcibly presses the unitary carrier against at an opposite second interior stop of the housing, thereby fixedly engaging the unitary carrier with the housing.

A eight embodiment is the optical transceiver device of any one of the first through seventh embodiments, wherein the unitary carrier further comprises a second attachment area disposed between the optical ferrule and the first mating end of the housing, such that when the plurality of optical fibers is received by, and permanently attached to, the first attachment area, the plurality of optical fibers is also received by, and secured to, the second attachment area.

A nineth embodiment is the optical transceiver device of the eighth embodiment, wherein the plurality of optical fibers is disposed in, and permanently attached to, a fiber-cable carrier, and wherein the fiber-cable carrier is removably secured to the second attachment area.

A tenth embodiment is the optical transceiver device of the nineth embodiment, wherein the second attachment area comprises at least one flexible latch for securing the fiber-cable carrier to the second attachment area.

An eleventh embodiment is the optical transceiver device of the tenth embodiment, wherein the at least one flexible latch is disposed on, and extends from, a bottom of the second attachment area, the bottom defining a through opening therein.

A twelfth embodiment is the optical transceiver device of any one of the first through eleventh embodiments further comprising an adaptor at least partially disposed inside, and removably assembled to, the housing and configured to receive and secure at least a front portion of the mating optical connector therein, the adaptor comprising a hollow interior extending between a first open end of the adaptor and an opposite second open end of the adaptor disposed between the first open end and the second mating end of the housing, wherein at least portions of the optical ferrule and the unitary carrier are disposed in the hollow interior of the adaptor.

A thirteenth embodiment is a unitary carrier configured to be forcibly and reversibly assembled to a housing of an optical transceiver device and comprising a unitary construction extending between opposing front and rear ends of the unitary carrier and comprising: a front portion defining a cavity for receiving and supporting an optical ferrule of the optical transceiver device, the cavity comprising a closed top and a closed bottom and extending from a rear open end of the cavity to a front open end of the cavity disposed at or near the front end of the unitary carrier; a rear portion extending from the rear open end of the cavity to the rear end of the unitary carrier and comprising a compartment for removably receiving and securing a fiber-cable carrier permanently attached to a plurality of optical fibers permanently attached to the optical ferrule; and a pair of resilient wing arms disposed on, and extending from, opposite sides, of the rear portion of the unitary carrier, such that when the unitary carrier is assembled to the housing of the optical transceiver device, the resilient wing arms are forcibly reversibly flexed by the housing to fixedly engage the unitary carrier with the housing.

A fourteenth embodiment is the unitary carrier of the thirteenth embodiment, wherein the compartment comprises an open top for receiving the fiber-cable carrier and an opposite bottom, the bottom of the compartment defining a through opening therein.

A fifteenth embodiment is the unitary carrier of the thirteenth or fourteenth embodiments, wherein the front portion of the unitary carrier comprises a bottom portion comprising the closed bottom of the cavity, the bottom portion comprising at least one through opening therein.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optical transceiver device comprising:
a housing having a first mating end and an opposite second mating end;
a circuit board at least partially disposed inside the housing and comprising a plurality of electrically conductive first pads disposed proximate the first mating end of the housing and at least one optical transceiver in electrical communication with at least some of the first pads and comprising at least one of an optical light source and an optical light detector;
a unitary carrier disposed inside the housing proximate the second mating end of the housing and comprising at least one resilient arm forcibly reversibly flexed by the housing to fixedly engage the unitary carrier with the housing; and
an optical ferrule at least partially disposed inside the unitary carrier proximate the second mating end of the housing and configured to mate with a mating optical ferrule of a mating optical connector, the optical ferrule comprising a first attachment area for receiving and permanently attaching to a plurality of optical fibers in optical communication with at least some of the at least one optical transceiver, and a light redirecting member for changing a direction of light received from an optical fiber received by, and permanently attached to, the first attachment area.

2. The optical transceiver device of claim 1, wherein the at least one optical transceiver comprises at least one discrete package attached to the circuit board and comprising at least one optoelectronic die chip comprising the at least one of the optical light source and the optical light detector.

3. The optical transceiver device of claim 1, wherein the at least one optical transceiver comprises a plurality of optical transceivers, each of the optical transceivers comprising at least one of an optical light source and an optical light detector.

4. The optical transceiver device of claim 1, wherein the at least one resilient arm of the unitary carrier comprises a pair of spaced apart of resilient arms, each of the resilient arms forcibly reversibly flexed by the housing to fixedly engage the unitary carrier with the housing.

5. The optical transceiver device of claim 4, wherein the spaced apart resilient arms are forcibly reversibly flexed away from each other by the housing to fixedly engage the unitary carrier with the housing.

6. The optical transceiver device of claim 5, wherein each of the spaced apart resilient arms is forcibly reversibly flexed by a first interior stop of the housing.

7. The optical transceiver device of claim 6, wherein the first interior stop forcibly presses the unitary carrier against at an opposite second interior stop of the housing, thereby fixedly engaging the unitary carrier with the housing.

8. The optical transceiver device of claim 1, wherein the unitary carrier further comprises a second attachment area disposed between the optical ferrule and the first mating end of the housing, such that when the plurality of optical fibers is received by, and permanently attached to, the first attachment area, the plurality of optical fibers is also received by, and secured to, the second attachment area.

9. The optical transceiver device of claim 8, wherein the plurality of optical fibers is disposed in, and permanently attached to, a fiber-cable carrier, and wherein the fiber-cable carrier is removably secured to the second attachment area.

10. The optical transceiver device of claim 9, wherein the second attachment area comprises at least one flexible latch for securing the fiber-cable carrier to the second attachment area.

11. The optical transceiver device of claim 10, wherein the at least one flexible latch is disposed on, and extends from, a bottom of the second attachment area, the bottom defining a through opening therein.

12. The optical transceiver device of claim 1 further comprising an adaptor at least partially disposed inside, and removably assembled to, the housing and configured to receive and secure at least a front portion of the mating optical connector therein, the adaptor comprising a hollow interior extending between a first open end of the adaptor and an opposite second open end of the adaptor disposed between the first open end and the second mating end of the housing, wherein at least portions of the optical ferrule and the unitary carrier are disposed in the hollow interior of the adaptor.

13. A unitary carrier configured to be forcibly and reversibly assembled to a housing of an optical transceiver device and comprising a unitary construction extending between opposing front and rear ends of the unitary carrier and comprising:
a front portion defining a cavity for receiving and supporting an optical ferrule of the optical transceiver device, the cavity comprising a closed top and a closed bottom and extending from a rear open end of the cavity to a front open end of the cavity disposed at or near the front end of the unitary carrier;
a rear portion extending from the rear open end of the cavity to the rear end of the unitary carrier and comprising a compartment for removably receiving and securing a fiber-cable carrier permanently attached to a plurality of optical fibers permanently attached to the optical ferrule; and
a pair of resilient wing arms disposed on, and extending from, opposite sides, of the rear portion of the unitary carrier, such that when the unitary carrier is assembled to the housing of the optical transceiver device, the resilient wing arms are forcibly reversibly flexed by the housing to fixedly engage the unitary carrier with the housing.

14. The unitary carrier of claim 13, wherein the compartment comprises an open top for receiving the fiber-cable carrier and an opposite bottom, the bottom of the compartment defining a through opening therein.

15. The unitary carrier of claim 13, wherein the front portion of the unitary carrier comprises a bottom portion comprising the closed bottom of the cavity, the bottom portion comprising at least one through opening therein.
